(19) United States
(12) Patent Application Publication
(10) Pub. No.: US 2025/0028284 A1
(43) Pub. Date: Jan. 23, 2025

(54) TIMEPIECE MEMBER, TIMEPIECE, AND METHOD FOR MANUFACTURING TIMEPIECE MEMBER

(71) Applicant: CASIO COMPUTER CO., LTD., Tokyo (JP)

(72) Inventors: Shouta NAGASAWA, Tokyo (JP); Masao AMANO, Tokyo (JP); Takayuki SHIMOKAWA, Tokyo (JP); Yousuke SASAKI, Tokyo (JP)

(73) Assignee: CASIO COMPUTER CO., LTD., Tokyo (JP)

(21) Appl. No.: 18/761,793

(22) Filed: Jul. 2, 2024

(30) Foreign Application Priority Data
Jul. 19, 2023 (JP) 2023-117579

(51) Int. Cl. G04B 45/00; G04B 19/28; G04D 3/00

(52) U.S. Cl. CPC G04B 45/0015; G04B 19/283; G04D 3/0069

(57) ABSTRACT

A timepiece member according to an aspect of the present disclosure includes: a base material having translucency, in which the base material includes a pattern portion including a plurality of display regions having different front surface states and exhibiting different appearances or textures, and the pattern portion exhibiting a predetermined pattern by a set of the plurality of display regions, and a color imparting layer is provided on a front surface of the base material so as to extend over the plurality of display regions.

### CROSS-REFERENCE TO RELATED APPLICATIONS

This application is based upon and claims the benefit of priority from Japanese Patent Application No. 2023-117579, filed Jul. 19, 2023, the entire contents of which are incorporated herein by reference.

### FIELD

The present disclosure relates to a timepiece member, a timepiece, and a method for manufacturing a timepiece member.

### BACKGROUND

Conventionally, as disclosed in Jpn. Pat. Appln. KOKAI Publication No. 58-221689, a front surface is processed to form various patterns in a timepiece member such as an exterior member of a timepiece.

### SUMMARY

A timepiece member according to an aspect of the present disclosure comprises:
a base material having translucency, in which
the base material includes a pattern portion including a plurality of display regions having different front surface states and exhibiting different appearances or textures, and the pattern portion exhibiting a predetermined pattern by a set of the plurality of display regions, and
a color imparting layer is provided on a front surface of the base material so as to extend over the plurality of display regions.

A method for manufacturing a timepiece member according to another aspect of the present disclosure comprises:
performing laser processing for a plurality of display regions under processing conditions different from each other so as to exhibit a predetermined pattern by a set of the plurality of display regions divided from each other in a target region of a front surface of a base material.

Further features of the present invention will become apparent from the following description of exemplary embodiments (with reference to the attached drawings).

### BRIEF DESCRIPTION OF DRAWINGS

FIG. 1 is a perspective view illustrating a configuration of a timepiece according to an embodiment.

FIG. 2 is a plan view illustrating the configuration of the timepiece.

FIG. 3 is a cross-sectional view illustrating the configuration of the timepiece.

FIG. 4 is a plan view of a bezel according to the embodiment.

FIG. 5 is an explanatory view of a pattern portion of the bezel according to the embodiment.

FIG. 6 is a cross-sectional view illustrating a configuration of the bezel of the timepiece.

FIG. 7 is a bottom view illustrating the pattern portion of the bezel according to the embodiment.

FIG. 8 is explanatory views illustrating a method for manufacturing the bezel according to the embodiment.

FIG. 9 is explanatory views illustrating the method for manufacturing the bezel according to the embodiment.

### DETAILED DESCRIPTION

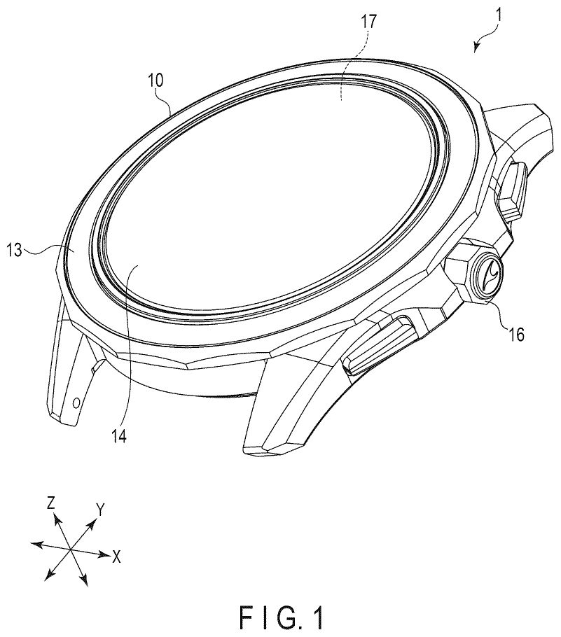

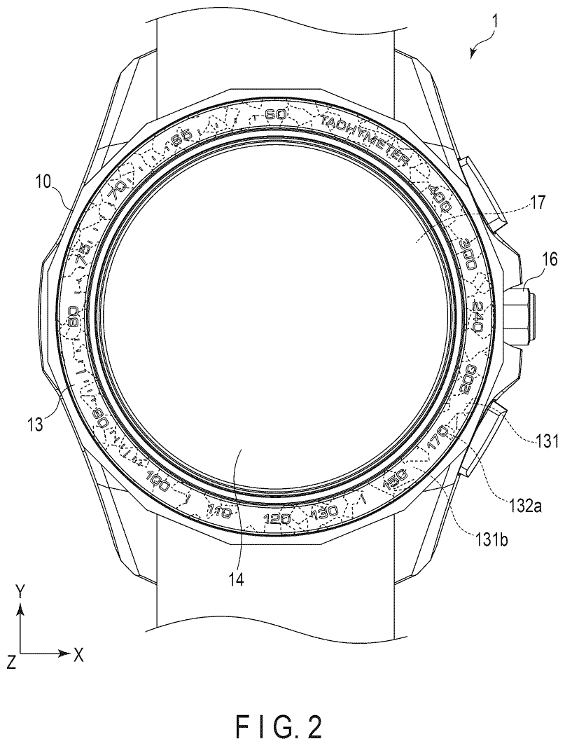

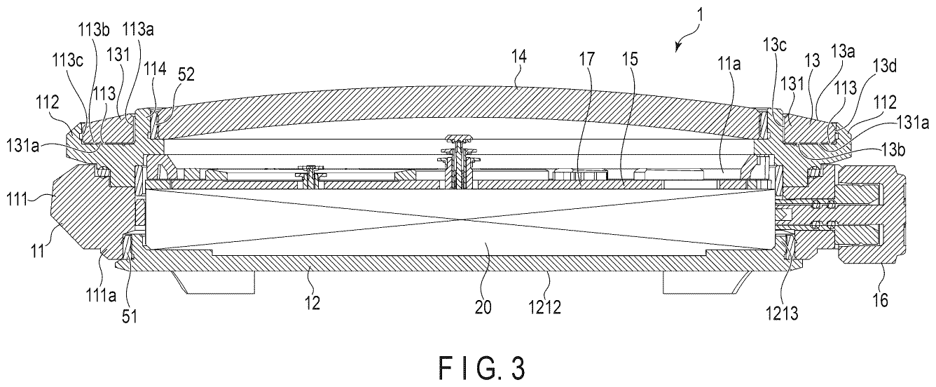

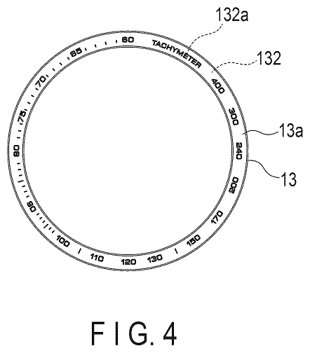

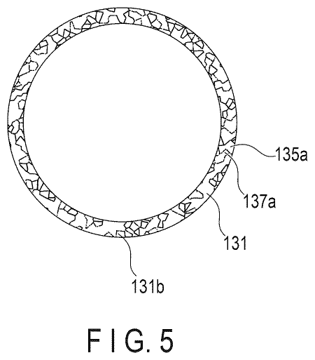

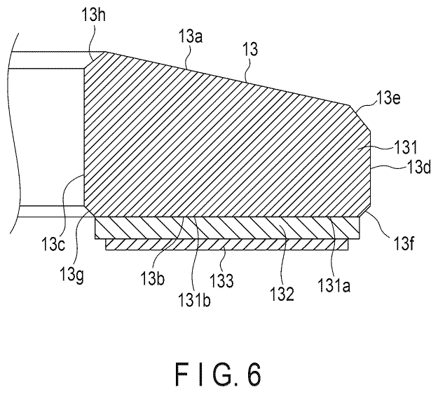

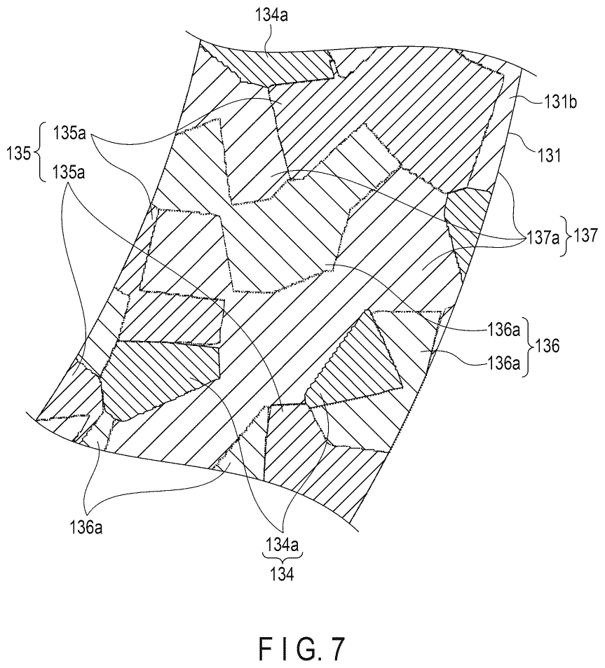

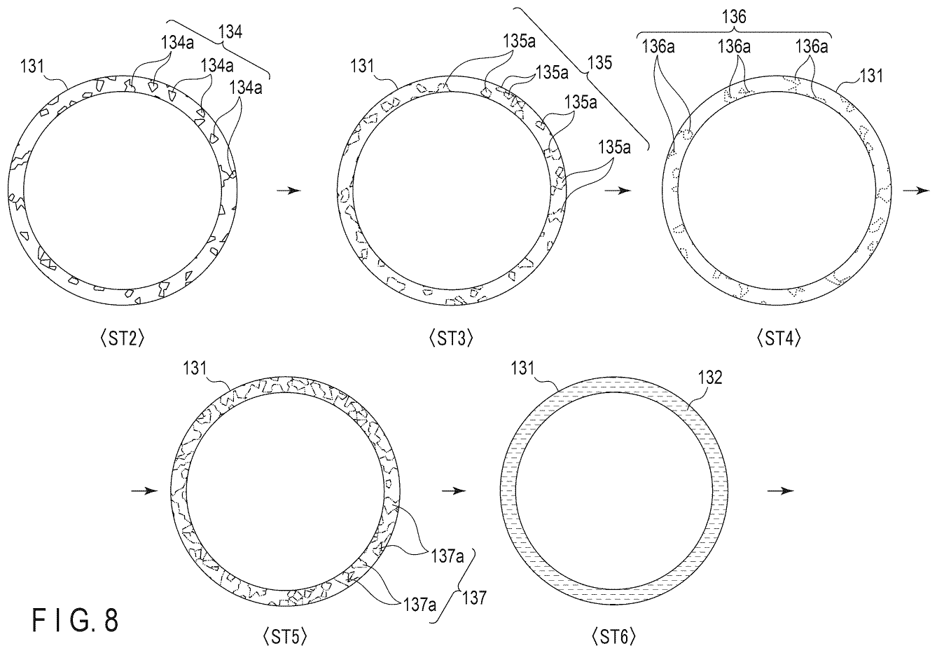

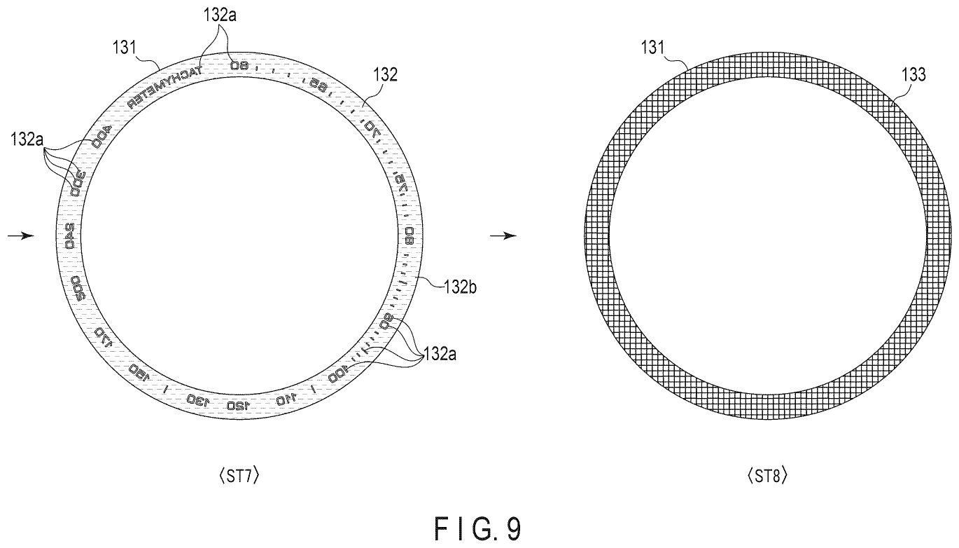

Hereinafter, a timepiece 1 as a device according to a first embodiment of the present invention and a method for manufacturing the timepiece 1 will be described with reference to FIGS. 1 to 8. FIG. 1 is a perspective view illustrating a configuration of the timepiece 1, and FIG. 2 is a plan view illustrating the configuration of the timepiece. FIG. 3 is a cross-sectional view illustrating the configuration of the timepiece, and FIG. 4 is a plan view of a bezel 13. FIG. 5 is a view of a pattern portion of the bezel as viewed from a back side, and FIG. 6 is a cross-sectional view of the bezel. FIG. 7 is a bottom view illustrating a pattern portion 131b of the bezel, and FIGS. 8 and 9 are explanatory views illustrating a method for manufacturing the bezel.

In the drawings, an X axis, a Y axis, and a Z axis represent three directions orthogonal to one another. Each drawing illustrates that the X axis is along a 3:00-9:00 direction and the Y axis is along a 12:00-6:00 direction in an analog-type timepiece, and the Z axis is along a front-back surface direction (first direction) in the timepiece 1 as an example. Note that, in each drawing, the configuration is schematically illustrated by being appropriately enlarged, reduced, or omitted.

In the present embodiment, the timepiece 1 will be described on the premise that a back lid 12 side is a back side and a direction in which an outer surface of a cover 14 such as a windshield member faces is a front side. For example, the timepiece 1 is worn on an arm with an outer-side surface of the back lid 12 facing the arm on which the timepiece is to be worn.

The timepiece 1 illustrated in FIGS. 1 to 3 is, for example, a wristwatch worn on a wrist of a user. The timepiece 1 includes a timepiece case 10, and a display unit 15 and a timepiece module 20 provided inside the timepiece case 10. In addition, the timepiece 1 includes a timepiece band connected to an outer peripheral portion of the timepiece case 10, and a plurality of switches and a knob 16 arranged on an outer periphery of the timepiece case 10.

The timepiece case 10 is formed in a circular shape, and includes a center case 11 as a center member disposed on an outer peripheral portion of the timepiece module 20, the back lid 12 disposed on the back side (back surface side) of the timepiece module 20, the bezel 13 as a device member disposed on an outer peripheral portion on the front side of the center case 11, and the cover 14 that covers the front side (front surface side) of the timepiece module 20 and the display unit 15. In the timepiece case 10, the center case 11 and the back lid 12 constitute a housing space in which the timepiece module 20 and the display unit 15 are disposed.

For example, the timepiece 1 is formed in a circular shape having a central axis along one direction as an example, and the center case 11, the back lid 12, the bezel 13, and the cover 14 constituting the timepiece case 10 are each formed in a concentric shape or a shape close to a concentric circle. Note that the shape of the timepiece 1 and each member is not limited to a circular shape, and may be a square shape or another shape.

The center case 11 is formed in a frame shape forming an opening in a center. The center case 11 has the front side of the opening covered with the cover 14, and the back side covered with the back lid 12, thereby forming a housing space 11a (housing portion) in which the timepiece module 20 and the display unit 15 are disposed. The center case 11 may be configured by combining a plurality of members. For example, the center case 11 includes a first case member 111 and a second case member 112.

The first case member 111 contains a metal material such as titanium, and is formed in a cylindrical shape having an axis along one direction. The first case member 111 has, for example, a peripheral wall portion disposed on the outer periphery of the timepiece module 20 and the display unit 15. The first case member 111 has an annular holding portion 111a to be engaged with the back lid 12 at an end on the back side. For example, the holding portion 111a is formed in an edge portion on the back side of an inner peripheral edge of the first case member 111 and has an engagement structure to be engaged with an engagement cylindrical portion 1213 of the back lid 12. The holding portion 111a holds the back lid 12 fitted via a connecting member 51 such as a packing or an adhesive. The second case member 112 is disposed on the front side of the first case member 111.

The second case member 112 contains a metal material such as titanium, and is formed in a cylindrical shape having an axis along one direction. For example, the second case member 112 has a peripheral wall portion disposed on an outer peripheral portion of the cover 14.

In addition, the second case member 112 has a peripheral groove-shaped recess 113 that is open to the front side and in which the bezel 13 is disposed. For example, the recess 113 is formed in a predetermined shape along the shape of bezel 13. As an example, the recess 113 has a first peripheral surface 113a facing an inner peripheral surface 13c of the bezel 13, a bearing surface 113b facing a back surface 13b of the bezel 13, and a second peripheral surface 113c along an outer peripheral surface 13d of the bezel. The bearing surface 113b forms a plane orthogonal to the first direction. The first peripheral surface 113a forms an outer wall surface rising from the bearing surface 113b toward the front side along the axial direction. The second peripheral surface 113c forms an inner wall surface rising from the bearing surface 113b toward the front side along the axial direction.

In addition, the second case member 112 has a holding frame 114 that holds the cover 14 via a connecting member 52 that is a waterproof member such as a packing on an inner peripheral side on the front side. That is, the cover 14 is attached to the inner peripheral side on the front side of the peripheral wall portion via the connecting member 52 such as a packing.

As an example, the members of the respective parts such as the center case 11, the back lid 12, the bezel 13, the cover 14, and a dial 17 are concentric, or have the same shape in the case of a rectangular shape such as an octagon, for example, and have shapes fitted to outer shapes of target members to be assembled to each other.

The back lid 12 is a plate-shaped member that covers the back side of the center case 11 and the timepiece module 20. For example, the back lid 12 contains, for example, a metal material, and integrally includes a plate portion 1212 formed in a plate shape and constituting a bottom portion of the timepiece case 10, and the engagement cylindrical portion 1213 erected from an outer peripheral edge of the plate portion 1212 to the front side.

The engagement cylindrical portion 1213 is a cylindrical member protruding to the front side. For example, the engagement cylindrical portion 1213 engages with the first case member 111 of the center case 11. The engagement cylindrical portion 1213 is inserted into the opening on the back side of the center case 11, and is fixed to the center case 11 by fastening, gluing, bonding, or the like. For example, the back lid 12 is bonded to the center case 11 via the connecting member 51 such as a packing or an adhesive.

As illustrated in FIGS. 1 to 6, the bezel 13 is formed in an annular plate shape having an opening. For example, the bezel 13 is an example of an exterior member, and protects and supports various components such as the cover 14. The bezel 13 is attached to the outer periphery on the front side of the center case 11. Specifically, the bezel 13 is disposed in the recess 113 formed in the second case member 112. The bezel 13 is fixed to the center case 11 by, for example, adhesion or by various fastening members. As an example, the bezel 13 is bonded to the center case 11 via a connecting member such as an adhesive or a fastening member.

The bezel 13 includes a bezel base 131 containing a translucent material, and a coating portion (color imparting layer) 132 formed on a front surface 13a of the bezel base 131.

The bezel base 131 contains a translucent material that transmits visible light, and is formed in a circular or polygonal annular shape. The bezel base 131 contains, for example, sapphire glass having a single crystal structure. As a specific example, as illustrated in FIG. 6, the bezel base 131 has the front surface 13a, the back surface 13b, the inner peripheral surface 13c, and the outer peripheral surface 13d, and is formed in an annular shape having a rectangular cross section. Corners formed between the front surface 13a and the inner peripheral surface 13c, the front surface 13a and the outer peripheral surface 13d, the back surface 13b and the inner peripheral surface 13c, and the back surface 13b and the outer peripheral surface 13d are chamfered to form tapered surfaces 13e, 13f, 13g, and 13h, respectively. An outer surface of the bezel 13 is mirror-finished to predetermined smoothness. For example, the bezel 13 has an axial dimension of 1.4 mm or more in thickness. For example, the thickness is 2 mm or more, and preferably 3 mm or more. The bezel 13 has the same shape as the recess 113 of the second case member 112 in plan view.

The inner peripheral surface 13c of the bezel 13 is formed in a curved shape having the same diameter as the first peripheral surface 113a of the recess 113 and extending in the axial direction. The outer peripheral surface 13d of the bezel 13 is formed in a curved shape having substantially the same diameter as the second peripheral surface 113c of the recess 113 and extending in the axial direction. That is, a very small gap is formed between the outer surface of the bezel 13 and an inner surface of the recess 113, or substantially no gap is formed.

The pattern portion 131b is formed on the front surface of the bezel base 131. The pattern portion 131b is provided on a surface on an inner side when incorporated in the timepiece 1. For example, the pattern portion 131b is provided on an inner-side surface disposed in the timepiece case 10 of the timepiece 1 or disposed opposite to another member, and not exposed to the outer surface side. As an example, the pattern portion 131b is provided on the back surface 13b of the bezel base 131. As an example, the pattern portion 131b is formed over the entire back surface 13b of the bezel 13.

As illustrated in FIGS. 5 to 7, the pattern portion 131b exhibits a predetermined pattern as a whole by a set of a plurality of processing regions 134 to 137 (display regions) having different processing conditions for front surface processing. The pattern portion 131b exhibits a predetermined pattern by contrast generated between the plurality of processing regions 134 to 137 having different front surface states.

The front surface state includes, for example, at least one of a front surface shape, a position (depth) of the front surface, front surface roughness, a reflection characteristic of light on the front surface, a scattering characteristic of light, an interference characteristic of light, brightness, or saturation, and when any one of these characteristics is different, a different texture is exhibited for each of the processing regions 134 to 137. As an example, the pattern portion 131b according to the embodiment forms a crystal-tone pattern by the four types of processing regions 134 to 137.

The plurality of processing regions 134 to 137 has a plurality of unit regions 134a to 137a arranged in a scattered manner. In FIG. 7, the plurality of unit regions 134a to 137a belonging to the same processing regions 134 to 137 is illustrated by the same type of hatching. The plurality of unit regions belonging to the same processing region is processed under the same processing condition, and exhibits the same front surface state or a common front surface state. That is, the first processing region 134 includes a plurality of scattered unit regions 134a, and the plurality of unit regions 134a is processed under the common processing condition and has a common appearance. The plurality of processing regions 134 to 137 is formed in different front surface shapes under different processing conditions. For example, the plurality of processing regions 134 to 137 is set at positions not overlapping one another. The pattern portion 131b is visually recognized so as to exhibit a predetermined pattern such as a crystal tone, a fiber tone, or a camouflage pattern when viewed as a whole by a set of the unit processing regions 134a to 137a of the plurality of processing regions 134 to 137.

The present embodiment illustrates an example in which a crystal-tone pattern is formed in the pattern portion 131b by the set of the plurality of unit processing regions 134a to 137a divided into polygonal shapes having irregular shapes and sizes. That is, the pattern portion 131b is configured by the set of the plurality of unit regions 134a to 137a, and at least one of the unit regions 134a to 137a has a polygonal shape. That is, at least a part of a boundary line between the plurality of processing regions 134 to 137 and between the unit regions 134a to 137a has a bent corner portion.

The plurality of processing regions 134 to 137 is formed by laser processing as an example of the front surface processing. For example, the front surface processing is performed using a processing device such as a laser processing machine capable of setting the processing regions and processing conditions. The processing device is configured to be able to set, for example, various conditions such as intensity of light to be emitted, a type of light, output, etching depth, a scanning direction, a scanning distance, and a scanning pitch for each area as condition settings.

Further, for example, the processing device selects, as the condition setting, a processing state such as honing, hairline, or hologram for each region, or selects and sets a processing stage and performs processing, thereby forming various front surface states.

As illustrated in FIGS. 4 and 6, the coating portion 132 is formed on the back surface 13b of the bezel base 131. The coating portion 132 reflects light in a certain wavelength range included in visible light, and is a blue thin film in the present embodiment. As an example, the coating portion 132 is a metal deposited film of metal formed by vapor deposition, for example. The coating portion 132 is disposed to overlap the back-side front surface of the pattern portion 131b formed on the back surface of the bezel base 131. The coating portion 132 may be formed on the back-side tapered surfaces 13f and 13g in addition to the back surface 13b of the bezel 13. For example, the coating portion 132 is provided to extend over a plurality of display regions.

The coating portion 132 functions as a color imparting layer. As a method for causing the coating portion 132 to impart color, for example, color may be imparted by interference by stacking a plurality of films, or color may be imparted by forming a single layer film having visibility. Further, as a method for forming the coating portion 132, a known method such as vapor deposition or sputtering may be used. Further, the method for forming the coating portion 132 is not limited to these exemplified methods, and the film forming method and the material used for the film formation may be appropriately selected so that the coating portion 132 or the back surface 13b of the bezel base 131 after the film formation can be visually recognized as a desired color.

As illustrated in FIGS. 4 and 6, the back surface 13b of the bezel 13 may have an etched portion 132a in which a part of the coating portion 132 has been removed. For example, in the coating portion 132 on the back surface of the bezel 13, the etched portion 132a in which a part of the coating portion 132 has been removed is formed in a pattern corresponding to a shape of a symbol such as a character or a scale, so that the shape of the symbol such as the character or the scale can be visually recognized from the front surface side.

The display unit 15 includes the dial 17 and a pointer for displaying information such as time and date. The dial 17 is formed in a disk or polygonal plate shape, and is disposed in an upper portion of the housing space 11a of the center case 11. On a front surface outer peripheral portion, which is one surface side of the dial 17, a parting member provided with various time characters is disposed. The pointer includes a needle body that is supported by a pointer shaft provided at a center of the dial 17 and rotates.

The timepiece module 20 includes various components necessary for a clock function, such as a movement for operating the display unit 15, a circuit board on which electronic components such as an IC and an antenna are mounted, and a battery. For example, the display unit 15 may be a digital system including a liquid crystal display panel or the like having a digital display function, or may be an analog system.

The cover 14 is a transparent member containing, for example, inorganic glass such as Si02 glass. For example, the cover 14 is a transparent disk-shaped timepiece glass, is arranged on the front side of the timepiece module 20 and the display unit 15, and covers the front side of the timepiece module 20 and the display unit 15. For example, the cover 14 is supported on an inner peripheral edge on the front side of the opening of the center case 11 via a connecting member such as a packing.

Next, a method for manufacturing the timepiece 1 according to the embodiment will be described with reference to FIGS. 8 and 9. FIGS. 8 and 9 are views for describing a method for manufacturing the bezel 13, and are flow views illustrating a flow of the method for manufacturing the bezel 13. In FIG. 8, in pieces of processing ST2 to ST5 of a pattern forming process, regions processed up to a previous stage are omitted, and the processing regions 134 to 137 that are processed in each of the processing processes ST2 to ST5 are separately illustrated.

The method for manufacturing the timepiece 1 according to the present embodiment includes a base processing step of processing the bezel base 131, a pattern forming step of forming a pattern on the back surface of the bezel base 131 by front surface processing, and an assembling step of assembling the produced bezel 13 to the center case 11. The method for manufacturing the timepiece according to the present embodiment includes performing the front surface processing for the plurality of processing regions divided from one another in a target region of a front surface of a base material under the different processing conditions to form a predetermined pattern by contrast generated between the plurality of processing regions.

In the production of the bezel 13, first, sapphire glass that serves as the base material is annularly formed (step ST1). Here, after the sapphire glass is processed to a final shape having each of the surfaces 13a to 13h, each of the surfaces 13a to 13h is mirror-finished. In step ST1, the bezel base 131 in a blank state (transparent) is produced.

Next, light irradiation processing is performed for the back surface 13b of the bezel base 131 after the processing step under a light irradiation condition different for each processing region as the front surface processing.

Specifically, as illustrated in FIG. 8, on the back surface of the bezel base 131, there are provided first front surface processing (step ST2) for applying laser etching processing to the first processing region 134 under a first condition, second front surface processing (step ST3) for applying the laser etching processing to the second processing region under a second condition, third front surface processing (step ST4) for applying the laser etching processing to the third processing region under a third condition, and fourth front surface processing (step ST5) for applying the laser etching processing to the fourth processing region under a fourth condition.

The processing conditions may be set by setting a state of front surface finish by setting a front surface processing device. For example, front surface finish such as a honing tone, a hairline tone in which a plurality of linear patterns aligned in one direction is formed, a hologram tone in which reflected light is reflected in various directions by fine irregularities and interferes with another reflected light may be selected for each processing region. Further, different conditions may be selected and set for the same type of finish. As an example, by setting a different processing condition for each region, such as a thin honing tone for the first processing region 134, a dark honing tone for the second processing region 135, a hairline tone for the third processing region 136, and a hologram tone for the fourth processing region 137, a different appearance and a different texture are formed for each region. As described above, the different front surface shapes are formed in the plurality of processing regions 134a to 137a, and the crystal-tone pattern illustrated in FIG. 7 is formed as a whole.

Next, on the back surface 13b of the bezel base 131 after the front surface processing, the coating portion 132, which is a metal deposited film, is formed by vapor deposition (step ST6).

Furthermore, as illustrated in FIG. 9, etching processing is performed for the coating portion 132 in a predetermined pattern to form the etched portion 132a in which the coating portion 132 has been removed (step ST7). At this time, for example, by forming the etched portion 132a in a pattern corresponding to the shape of various characters, scales, symbols, and the like, the various characters, scales, and symbols can be visually recognized from the front surface.

Note that the process of forming the coating portion 132 and the etched portion 132a is performed at timing after the laser processing for the bezel base 131 and before assembly to the center case 11.

Next, a printing layer 133 (second color imparting layer) that imparts color in a visible manner may be further formed to overlap the back-side front surface of the coating portion 132 including the etched portion 132a in which the coating portion 132 has been removed by etching (step ST8). That is, after the coating portion 132 is partially removed, the printing layer 133 is formed so as to extend from the etched portion 132a in which the part has been removed over a portion 132b where the coating portion 132 other than the etched portion 132a remains. As an example, the printing layer 133 is formed so as to overlap the metal deposited film of the coating portion 132 on the entire back surface of the bezel base 131. In this case, the color of the printing layer 133 is arranged to overlap the back-side surface of the transparent bezel base 131 of the etched portion 132a removed by etching, so that the various characters, scales, and symbols of the etched portion 132a can be seen as the color of the printing layer 133 from the front side, as illustrated in FIG. 2 when viewed from the front side.

As described above, the bezel 13 is produced in which the coating portion 132 as an opaque layer is formed on the back surface 13b and the tapered surface 13f on the back side.

Furthermore, the bezel 13 is assembled to the center case 11 by being inserted into the recess 113 of the center case 11 (step ST8).

According to the timepiece 1 and the timepiece case 10 configured as described above, since the pattern is expressed by the set of the plurality of processing regions having the different processing conditions, various patterns can be expressed.

For example, in the case where coloring is performed by vapor deposition or the like, the vapor deposition and peeling need to be repeatedly performed in order to exhibit a different color for each region, and the procedure becomes very complicated. However, various patterns can be expressed by changing the conditions of the laser irradiation in the front surface processing for the transparent base material, and by the set of the plurality of regions expressing different appearances and textures. Therefore, it is sufficient that the vapor deposition processing is performed only once, and the peeling processing may not be performed. For example, by forming the shape of the processing region into an irregular polygonal shape, a crystal-tone pattern can be expressed.

Note that the above-described embodiment is merely an example, and does not limit the scope of the invention.

For example, in the above embodiment, the four types of processing regions is set, but the present invention is not limited thereto. Further, the regions are arranged not to overlap one another, but the present invention is not limited thereto. For example, a portion to be processed in an overlapping manner under a plurality of conditions can be formed and set as another region.

For example, the above embodiment illustrates the processing regions to which the processing has been performed under the various conditions as the front surface region. However, a non-processing region for which no processing is performed may be provided as the front surface region. That is, a region where processing is not performed may be included as one of the processing conditions.

Further, the example in which the pattern portion 131b is formed on the inner-side surface of the timepiece 1, that is, on the back surface of the bezel 13 in the case of the above embodiment has been described, but the present invention is not limited thereto. For example, the pattern portion 131b may be formed on a portion exposed to an outer surface side of a timepiece member.

Note that, in the above embodiment, the pattern portion 131b is formed on the back surface of the bezel 13, and the coating portion 132, which is a vapor deposited film, is formed on the pattern portion 131b on the back surface side of the bezel 13. However, the present invention is not limited to thereto. The coating portion 132 may be formed on a surface of the bezel 13, the surface being opposite to the surface on which the pattern portion 131b is formed. That is, the pattern portion 131b may be formed on the front surface of the bezel 13, and the coating portion 132 may be formed on the back surface of the bezel 13. In some cases, the pattern portion 131b may be formed on the front surface of the bezel 13, and the coating portion 132 may be formed to overlap the pattern portion 131b on the front surface side of the bezel 13.

Further, the pattern of the pattern portion 131b is not limited to a crystal tone. As described above, as the pattern of the pattern portion 131b, various patterns can be formed such as a camouflage pattern, a carbon tone, a plain weave tone, and a fiber tone, and can be applied to various patterns that are formed by a set of a plurality of portions having different front surface shapes. For example, the pattern such as a plain weave pattern or a carbon tone pattern can be expressed by dividing a region in a grid manner and alternately arranging the regions in each of which longitudinal or lateral fibrous pattern is formed in the longitudinal and lateral directions. Note that the shape of the region may be regular or irregular.

Further, as another embodiment, for example, a pattern portion having a common characteristic in texture to another portion constituting the same device may be formed. For example, a timepiece includes a separate member containing a metal material and having at least a front surface on a visually recognized side to which processing is applied so as to exhibit a common pattern to the pattern portion. For example, the timepiece includes a separate member exhibiting a crystal-tone appearance due to recrystallization of a metal material as the dial 17 constituting the display unit 15, and the bezel has a configuration in which a plurality of processing regions processed on sapphire glass under different conditions is formed, and the set of the plurality of processing regions exhibits a crystal-tone appearance, so that uniformity in appearance can be provided as the entire device.

Further, the color of the coating portion 132 may be color other than blue. Further, in a case of forming a plurality of coating portions 132 corresponding to a plurality of non-visually recognized-side surfaces, these colors may be different.

Further, the coating portion 132 that is a deposited film may not be formed.

Further, in the above embodiment, the timepiece case 10 has been exemplified as an example of the device, and the bezel 13 has been exemplified as the timepiece member, but the present invention is not limited thereto. For example, the present invention is also applicable to other timepiece members such as the cover 14, the knob 16, the dial 17, and the back lid 12 of the timepiece 1. Further, for example, the present invention can also be applied to various wearable devices such as a wrist device that handles biological information in addition to the time function.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

What is claimed is:

1. A timepiece member comprising
a base material having translucency, wherein
the base material includes a pattern portion including a plurality of display regions having different front surface states and exhibiting different appearances or textures, the pattern portion exhibiting a predetermined pattern by a set of the plurality of display regions, and
a color imparting layer is provided on a front surface of the base material so as to extend over the plurality of display regions.

2. The timepiece member according to claim 1, wherein the plurality of display regions has different states including at least one of a front surface shape, a position of a front surface, front surface roughness, a reflection characteristic of light, a scattering characteristic of light, an interference characteristic of light, brightness, or saturation.

3. The timepiece member according to claim 1, wherein each of the plurality of display regions is formed by a plurality of unit regions arranged in a scattered manner.

4. The timepiece member according to claim 3, wherein
at least one of the unit regions has a polygonal shape, and
at least a part of a boundary line between the plurality of display regions has a bent corner portion.

5. The timepiece member according to claim 1, wherein,
in the color imparting layer, a part of a region to overlap the display region is removed, and
a second color imparting layer provided so as to extend from a portion in which the color imparting layer has been removed over a portion in which the color imparting layer remains is further provided.

6. The timepiece member according to claim 1, wherein the plurality of display regions does not overlap each other.

7. A timepiece comprising:
a case;
a timepiece module housed in the case; and
the timepiece member according to claim 1 assembled to the case.

8. The timepiece according to claim 7, wherein the pattern portion is provided on a surface of the timepiece member, the surface being on an inner side when the timepiece member is incorporated in the timepiece.

9. The timepiece according to claim 7, wherein
the base material is a transparent member, and
a separate member that exhibits a pattern common to the pattern portion and contains a metal material is provided.

10. The timepiece according to claim 9, wherein
the timepiece member is a bezel of the timepiece, and
the separate member is a dial of the timepiece.

11. A method for manufacturing a timepiece member comprising:
performing laser processing for a plurality of display regions under processing conditions different from each other so as to exhibit a predetermined pattern by a set of the plurality of display regions divided from each other in a target region of a front surface of a base material.

12. The method for manufacturing a timepiece member according to claim 11, wherein the laser processing is irradiation processing of irradiation with light, and the processing conditions including at least one of a type of the light, intensity of the light, output, a scanning distance of the light irradiation, a scanning direction of the light irradiation, or a scanning pitch of the light irradiation are different from each other in the plurality of display regions.

13. The method for manufacturing a timepiece member according to claim 12, wherein
the base material has translucency, and
the method further comprises providing a color imparting layer over the plurality of display regions on the front surface of the base material.

14. The method for manufacturing a timepiece member according to claim 13, further comprising: after partially removing the color imparting layer, providing a second color imparting layer so as to extend from a portion in which the color imparting layer has been removed over a portion in which the color imparting layer remains.

15. A method for manufacturing a timepiece comprising:
performing laser processing for a plurality of display regions under processing conditions different from each other so as to exhibit a predetermined pattern by a set of the plurality of display regions divided from each other in a target region of a front surface of a base material; and
assembling a timepiece member including the base material to a case in which a timepiece module and a dial are housed.

16. The method for manufacturing a timepiece according to claim 15, wherein a color imparting layer is provided on the front surface of the base material for which the laser processing has been performed, before the base material is assembled to the case.

17. The method for manufacturing a timepiece according to claim 16, comprising: partially removing the color imparting layer, and providing a second color imparting layer so as to extend from a portion in which the color imparting layer has been removed over a portion in which the color imparting layer remains, before assembling the base material to the case.

18. The method for manufacturing a timepiece according to claim 15, wherein the dial contains a metal material, and is processed such that at least a front surface on a visually recognized side exhibits a pattern common to the pattern of the target region.
